(19) United States
(12) Patent Application Publication
(10) Pub. No.: US 2006/0268091 A1
(43) Pub. Date: Nov. 30, 2006

(54) METHOD OF CONTROLLING LIGHT SOURCES IN AN ELECTRO-PHOTOGRAPHIC IMAGE FORMING DEVICE, AN IMAGE FORMING METHOD, AND AN APPARATUS THEREOF

(76) Inventor: Yang-o KIM, Seoul (KR)

Correspondence Address: STANZIONE & KIM, LLP, 919 18TH STREET, N.W., SUITE 440, WASHINGTON, DC, 20006, US

(21) Appl. No.: 11/420,979

(22) Filed: May 30, 2006

(30) Foreign Application Priority Data
May 31, 2005 (KR) 2005-46117

(51) Int. Cl. G03G 15/01

(52) U.S. Cl. 347/115

(57) ABSTRACT

A method of controlling a plurality of light sources included in a multi-beam laser scanning unit in an electro-photographic image forming apparatus, an image forming method, and an apparatus thereof. The image forming method includes detecting remaining amounts of toner that correspond to printable colors, detecting any color having a remaining amount of toner that is depleted based on the detected remaining amounts of toner, and radiating light onto a photosensitive medium by using selected ones of the plurality of light sources with respect to the color having the detected remaining amount of toner that is depleted. Accordingly, in the electro-photographic image forming apparatus having the plurality of light sources, the amounts of remaining toner of corresponding printable colors are detected so that the selected ones of the plurality of light sources among the plurality of light sources can be used when radiating light onto the photosensitive medium for the color having the remaining amount of toner that is depleted. Therefore, without an additional image data conversion, the amounts of remaining toner of the corresponding printable colors can be evenly maintained to uniformly preserve the quality of printed images.

### CROSS-REFERENCE TO RELATED APPLICATIONS

This application claims the benefit of Korean Patent Application No. 2005-46117, filed on May 31, 2005, in the Korean Intellectual Property Office, the disclosure of which is incorporated herein in its entirety by reference.

### BACKGROUND OF THE INVENTION

1. Field of the Invention

The present general inventive concept relates to an electro-photographic image forming apparatus, and more particularly, to a method of controlling a plurality of light sources included in a multi-beam laser scanning unit in the electro-photographic image forming apparatus, an image forming method, and an apparatus thereof.

2. Description of the Related Art

Generally, in an electro-photographic image forming apparatus, light is directed onto a uniformly charged photosensitive medium to form an electrostatic latent image, a toner is supplied to the electrostatic latent image to form a toner image, and the toner image is transferred and fused onto a recording medium to form an image. A laser scanning unit has been introduced to provide the light onto the photosensitive medium in the electro-photographic image forming apparatus. In order to enhance printing speed, a multi-beam laser scanning unit has recently been developed. The multi-beam laser scanning unit can either use a light source capable of generating multiple beams or a plurality of light sources in order to scan multiple lines at the same time.

The electro-photographic image forming apparatus includes developing units charged with toners of printable colors, for example, cyan, magenta, yellow, and black. If any one of the color toners is depleted, the print quality of color images formed on the photosensitive medium deteriorates.

### SUMMARY OF THE INVENTION

The present general inventive concept provides a method of controlling a plurality of light sources included in a multi-beam laser scanning unit in an electro-photographic image forming apparatus, an image forming method, and an apparatus thereof.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a method of controlling a plurality of light sources in an electro-photographic image forming apparatus, the method comprising detecting remaining amounts of toner that correspond to printable colors, detecting whether any color has a remaining amount of toner that is depleted based on the detected remaining amounts of toner, and radiating light onto a photosensitive medium by using selected ones of the plurality of light sources with respect to the color having the detected remaining amount of toner that is depleted.

The plurality of light sources may radiate light onto the photosensitive medium to form an electrostatic latent image.

In addition, the detecting of the remaining amounts of toners that correspond to the printable colors may comprise detecting a color having a remaining amount of toner that is less than a product value of multiplying a maximum of the detected remaining amounts of toner by a predetermined value “x” (0<x<1).

The predetermined value “x” may be set by one of a manufacturer and a user.

In addition, the radiating of the light may comprise radiating light onto the photosensitive medium using one of the plurality of light sources for the color having the remaining amount of toner that is depleted, and radiating light onto the photosensitive medium using two or more of the plurality of light sources for other colors that do not have remaining amounts of toner that are depleted.

The foregoing and/or other aspects of the present general inventive concept are also achieved by providing an electro-photographic image forming method, the method comprising detecting remaining amounts of toner that correspond to printable colors, detecting whether any color has a remaining amount of toner that is depleted based on the detected remaining amounts of toner, radiating light onto a photosensitive medium by using selected ones of a plurality of light sources with respect to the color having the detected remaining amount of toner that is depleted, and forming an image on a recording medium using the photosensitive medium onto which the light is radiated.

The printable colors may include yellow, magenta, cyan, and black.

In addition, the detecting of the remaining amounts of toner that correspond to the printable colors may comprise detecting a color having a remaining amount of toner that is less than a product value of multiplying a maximum of the detected remaining amounts of toner by a predetermined value “x” (0<x<1).

The radiating of the light may comprise radiating the light onto the photosensitive medium using one of the plurality of light sources for the color having the remaining amount of toner that is depleted, and radiating light onto the photosensitive medium using two or more of the plurality of light sources for other colors that do not have remaining amounts of toner that are depleted.

In addition, the radiating of the light may comprise determining a number of radiating light sources among the plurality of light sources to be in proportion to the detected remaining amounts of toner of the color having the remaining amount of toner that is depleted, and radiating the light onto the photosensitive medium using the determined number of light sources for the determined color having the remaining amount of toner that is depleted.

The foregoing and/or other aspects of the present general inventive concept are also achieved by providing an electrophotographic image forming method of maintaining approximately uniform amounts of different color toners, the method comprising controlling a plurality of light sources in a multi-beam light scanning unit such that a normal number of the plurality of light sources emit light to a photosensitive medium for a color having a corresponding normal remaining amount of toner and a reduced number of the plurality of light sources emit light to the photosensitive medium for a color having a corresponding depleted remaining amount of toner.

The foregoing and/or other aspects of the present general inventive concept are also achieved by providing an electrophotographic image forming method, the method comprising comparing relative remaining amounts of a plurality of different color toners in a plurality of corresponding developing units, and regulating a light scanning operation of a multi-beam light unit according to the comparison of the relative remaining amounts of the different color toners to operate different numbers of light sources for the different color toners such that the relative remaining amounts of the different color toners are maintained approximately uniform.

The foregoing and/or other aspects of the present general inventive concept are also achieved by providing an electro-photographic image forming apparatus, comprising a photosensitive medium on which an electrostatic latent image is formed, a plurality of light sources to radiate light onto the photosensitive medium, a plurality of developing units charged with toner of printable colors, a remaining toner detecting unit to detect amounts of remaining toner that correspond to the printable colors, a color determining unit to determine a color having a remaining toner amount of toner that is depleted according to the detected remaining amounts of toner, and a light source controlling unit to control the plurality of light sources such that selected ones of the plurality of light sources radiate light onto the photosensitive medium for the determined color having the remaining amount of toner that is depleted.

The printable colors may include yellow, magenta, cyan, and black.

In addition, the color determining unit may determine the color having the remaining amount of toner that is depleted by determining a color having the remaining amount of toner that is less than a product value of multiplying a maximum of the detected remaining amounts of toner by a predetermined value “x” (0<x<1) as the color having the remaining amount of toner that is depleted.

The light source controlling unit may control the plurality of light sources so that one light source radiates light onto the photosensitive medium for the color having the remaining amount of toner that is depleted, and may control two or more of the plurality of light sources to radiate light onto the photosensitive medium for other colors that do not have remaining amounts of toner that are depleted.

In addition, the light source controlling unit may determine a number of radiating light sources among the plurality of light sources to be in proportion to the detected remaining amounts of toner with respect to the determined color having the remaining amount of toner that is depleted so that the determined number of light sources are radiated onto the photosensitive medium.

The embodiments of the present general inventive concept may be written as computer readable code on computer readable medium.

The foregoing and/or other aspects of the present general inventive concept are also achieved by providing an electrophotographic image forming apparatus that maintains approximately uniform amounts of different color toners, the apparatus comprising a multi-beam light source unit including a plurality of light sources, and a controlling unit to control the plurality of light sources such that a normal number of the plurality of light sources emit light to a photosensitive medium for a color having a corresponding normal remaining amount of toner and a reduced number of the plurality of light sources emit light to the photosensitive medium for a color having a corresponding depleted remaining amount of toner.

The foregoing and/or other aspects of the present general inventive concept are also achieved by providing an electrophotographic image forming apparatus, comprising a photosensitive medium on which an electrostatic latent image that corresponds to a plurality of color toner images is formed, a multi-beam light source unit having a plurality of light sources, and a controlling unit to control the plurality of light sources to emit light to the photosensitive medium to form a first color toner image thereon and to control less than all of the plurality of light sources to emit light to the photosensitive medium to form a second color toner image thereon.

The foregoing and/or other aspects of the present general inventive concept are also achieved by providing a controller to control multi-beam laser scanning unit, the controller comprising a color determining unit to compare relative remaining amounts of a plurality of different color toners in a plurality of corresponding developing units, and a light source controlling unit to regulate a light scanning operation of the multi-beam laser scanning unit according to the comparison of the relative remaining amounts of the different color toners to operate different numbers of light sources for the different color toners such that the relative remaining amounts of the different color toners are maintained approximately uniform.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic diagram illustrating an electro-photographic image forming apparatus according to an embodiment of the present general inventive concept;

FIG. 2 is a schematic plan view illustrating a laser scanning unit of the electro-photographic image forming apparatus of FIG. 1;

FIG. 3 is a structural block diagram of a controlling unit which controls a plurality of light sources included in a multi-beam laser scanning unit according to an embodiment of the present general inventive concept; and

FIG. 4 is a flowchart illustrating a method of controlling the plurality of light sources included in the multi-beam laser scanning unit of FIG. 3 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

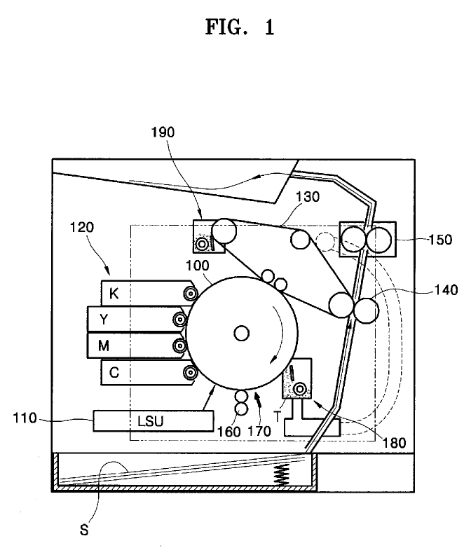

FIG. 1 is a schematic diagram illustrating an electro-photographic image forming apparatus. The electro-photographic image forming apparatus includes a photosensitive medium 100, a laser scanning unit (LSU) 110, developing units 120, a transfer belt 130, a transfer roller 140, a fuser unit 150, a charging unit 160, a static eliminating unit 170, a photosensitive medium cleaning unit 180, and a transfer belt cleaning unit 190.

The charging unit 160 uniformly charges the photosensitive medium 100. The LSU 110 radiates light associated with image data onto the photosensitive medium 100 to form an electrostatic latent image. The LSU 110 is a kind of a laser scanning unit that uses a laser diode as a light source to radiate light onto the photosensitive medium 100.

The developing units 120C, 120M, 120Y, and 120K respectively may include cyan, magenta, yellow, and black solid powder toners. In order to form toner images, the toner is supplied to the electrostatic latent image which is formed on the photosensitive medium 100.

As a temporary transfer medium, the transfer belt 130 receives the toner images from the photosensitive medium 100 to transfer the toner images onto a recording medium S. The cyan, magenta, yellow, and black toner images (color toner images) are formed sequentially on the photosensitive medium 100. The toner images are then transferred and sequentially superimposed on the transfer belt 130 to form the color toner images.

The transfer roller 140 is positioned opposite the transfer belt 130. The color toner images are brought into contact with the transfer belt 130 and are completely transferred thereto. The color toner images are then transferred onto the recording medium S. When the recording medium S having the color toner images thereon passes through the fuser unit 150, the color toner images are fused by heat and pressure. The static eliminating unit 170 eliminates residual charge from the photosensitive medium 100. In addition, the photosensitive medium cleaning unit 180 and the transfer belt cleaning unit 190 eliminate residual toner from the photosensitive medium 100 and the transfer belt 130, respectively.

Operation of an electro-photographic image forming apparatus according to an embodiment of the present general inventive concept will now be described. Here, color image data is a mixture of data associated with various colors, for example, cyan, magenta, yellow, and black. In the present embodiment, the cyan, magenta, yellow, and black toner images may be sequentially superimposed onto the transfer belt 130. The color toner images are then transferred and fused onto the recording medium S to form the color toner images.

When an optical signal that corresponds to cyan image data is radiated onto the uniformly charged photosensitive medium 100, a resistance of the radiated portion is reduced so that electric charge is removed from an outer surface of the photosensitive medium 100. As a result, a voltage difference is generated between the radiated (i.e., illuminated) portion and other portions (i.e., non-radiated portions) to form the electrostatic latent image on the outer surface of the photosensitive medium 100. Next, when the electrostatic latent image approaches the developing unit 120C by rotation of the photosensitive medium 100, the cyan toner in the developing unit 120C is transferred to the electrostatic latent image to form the cyan toner image. As the cyan toner image approaches the transfer belt 130 by further rotation of the photosensitive medium 100, the cyan toner image is transferred onto the transfer belt 130 by electric potential difference and/or contact pressure therebetween. When the cyan toner image is completely transferred onto the transfer belt 130, the magenta, yellow, and black toner images are also transferred and superimposed onto the transfer belt 130 in a similar manner as the aforementioned operation to form the color toner images. When the recording medium S passes between the transfer belt 130 and the transfer roller 140, the color toner images are transferred onto the recording medium S. The fuser unit 150 then fuses the color toner images onto the recording medium S by heat and pressure and discharges the recording medium S. Accordingly, the color image forming is completed.

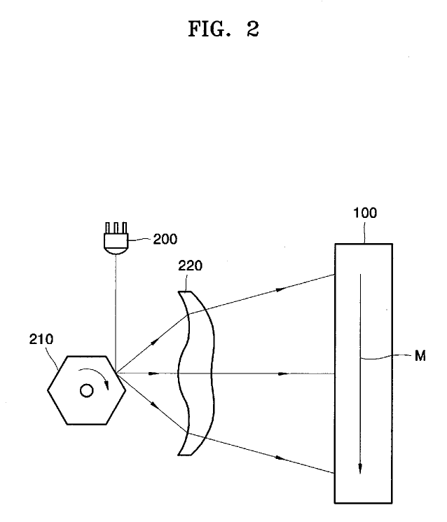

FIG. 2 is a schematic plan view illustrating the LSU 110. The LSU includes a light source 200, a rotating polygonal mirror 210, and an image forming lens 220. Light from the light source 200 is deflected along a main scanning direction M by the rotating polygonal mirror 210, and the deflected light is formed into images on the photosensitive medium 100 by the image forming lens 220.

Alternatively, the LSU 110 may be a multi-beam LSU including a plurality of light sources 200, such as a semiconductor laser having a plurality of light sources. When the semiconductor laser having the plurality of light sources is used as the LSU 110, multiple beams are radiated from the plurality of light sources so that a plurality of scanning lines are formed on the photosensitive medium 100 at the same time as opposed to sequentially.

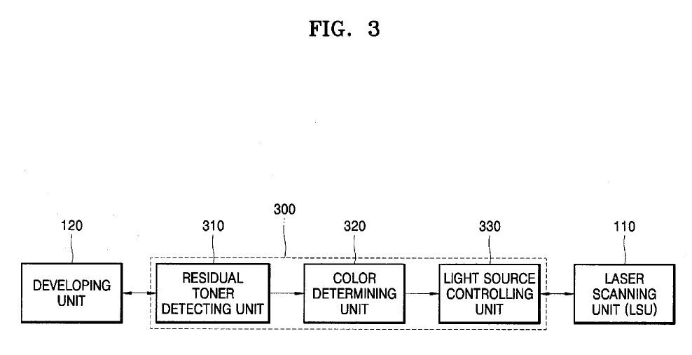

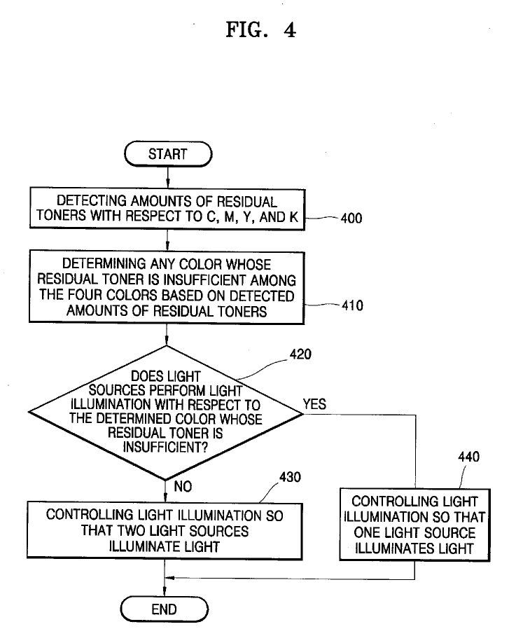

FIG. 3 is a structural block diagram illustrating a controlling unit 300 which controls the plurality of light sources included in the multi-beam LSU according to an embodiment of the present general inventive concept. The controlling unit 300 includes a residual toner detecting unit 310, a color determining unit 320, and a light source controlling unit 330. Referring now to FIG. 4, the controlling unit 300 will be described with reference to a flowchart illustrating a method of controlling the plurality of light sources included in the multi-beam LSU according to an embodiment of the present general inventive concept.

The residual toner detecting unit 310 detects an amount of toner remaining (residual) in each of the developing units 120C, 120M, 120Y, and 120K (operation 400). The color determining unit 320 receives information related to the amounts of remaining cyan, magenta, yellow, and black toner from the remaining (residual) toner detecting unit 310 to determine whether any color is depleted or insufficient (i.e., whether any color has a remaining amount of toner that is depleted) (operation 410).

In the operation 410, in order to determine whether any color has the remaining amount of toner that is depleted, a maximum of the detected amounts of remaining toner is multiplied by a prescribed (predetermined) value “x” (0<x<1) to obtain a product value, so that a color having a remaining amount of toner that is less than the product value is determined to be a depleted color. For example, if the remaining amounts of cyan, magenta, yellow, and black toner are respectively 1.4, 1.8, 2, and 1.7, and the prescribed value “x” is 0.8, the maximum remaining value, 2, is multiplied by 0.8. Then, since the cyan value is less than the calculated result, 1.6, the cyan toner is determined to have a remaining amount of toner that is depleted.

The prescribed value “x” may be in the range of 0 to 1. In addition, the prescribed value “x” may be set initially by a manufacturer or by a subsequent user.

The light source controlling unit 330 then determines (checks) whether the plurality of light sources included in the LSU 110 are to form an image of the depleted color (operation 420). If the LSU 110 is to form the image of the depleted color, one of the plurality of light sources is radiated onto the photosensitive medium 100 to form the electrostatic latent image for the depleted color (operation 440). If the LSU 110 does not form an image of a depleted color, two light sources are radiated onto the photosensitive medium 100 (operation 430). It should be understood that although the method of FIG. 4 illustrates that either one or two light sources can be used to form the electrostatic latent images, other numbers of light sources may alternatively be used.

Hereinafter, a method of controlling three or more light sources included in the multi-beam laser scanning unit with respect to the depleted color according to the operation 410 will be described. When the three or more light sources are used, the number of radiating light sources that is to be used to radiate the photosensitive medium 100 to form the electrostatic latent image for the depleted color is determined in proportion to the amounts of remaining toner. However, if less than half of the light sources are radiated onto the photosensitive medium 100 to form the electrostatic latent image, there may be a problem in that printing quality significantly deteriorates. Therefore, the number of radiating light sources used to form the electrostatic latent image is at least half of the total number of light sources in the LSU 110.

In particular, if the total number of light sources is N, where N is an even number, a range of remaining amount of toner from zero to the product value of multiplying the maximum value of the remaining amounts of toner by the prescribed value “x” determined according to the operation 410 is divided into N/2 sections to be evenly sectioned to correspond to numbers of light sources to be used from N/2 to N. Next, it is determined to which of the aforementioned divided sections the remaining amount of depleted toner corresponds by comparing the remaining amount of depleted toner to each divided section (e.g., by comparing the remaining amount of depleted toner to upper and lower limits of the divided section). If the remaining amount of depleted toner belongs to a first section that close to zero, light may be radiated by N/2 light sources. If the remaining amount of depleted toner corresponds to a second section adjacent to the first section, light may be radiated by N/2+1 light source. If the remaining amount of depleted toner corresponds to a third section adjacent to the second section, light may be radiated by N/2+2 light sources, so that as many as N−1 light sources are used if the remaining amount of depleted toner belongs to a last section which is closest to the product value. In other words, the operation 410 may include determining a degree of depletedness of the color having the remaining toner amount that is depleted from among a plurality of degrees of depletedness associated with a plurality of reduced numbers of light sources ranging from N/2 to N. In this manner, a color having a remaining toner amount that is only mildly depleted can have a corresponding color image that is scanned using almost all of the light sources (N), while a color having a remaining toner amount that is heavily depleted can have a corresponding color image that is scanned using half or more of the light sources (N/2).

In addition, if the total number of light sources is N, where N is an odd number, the range of zero to the product value of multiplying the maximum value of the remaining amounts of toner by the prescribed value “x” determined according to the operation 410 is divided into (N−1)/2 sections to be evenly sectioned. Next, it is determined to which of the aforementioned divided sections the remaining amount of depleted toner corresponds by comparing the remaining amount of depleted toner to each divided section (e.g., by comparing the remaining amount of depleted toner to the upper and lower limits of the divided section). If the remaining amount of depleted toner corresponds to the first section that is close to zero, light may be radiated by (N−1)/2 light sources. If the remaining amount of depleted toner corresponds to the second section adjacent to the first section, light may be radiated by (N−1)/2+1 light sources. If the remaining amount of depleted toner belongs to the third section adjacent to the second section, light may be radiated by (N−1)/2+2 light sources, so that as many as N−1 light sources are used if the remaining amount of depleted toner belongs to the last section which is closest to the product value.

In an embodiment of the present general inventive concept an electrophotographic image forming apparatus that maintains approximately uniform amounts of different color toners includes a multi-beam light scanning unit having a plurality of light sources, and a controlling unit to control the plurality of light sources such that a normal number of the plurality of light sources emit light to a photosensitive medium for a color having a corresponding normal remaining amount of toner and a reduced number of the plurality of light sources emit light to the photosensitive medium for a color having a corresponding depleted remaining amount of toner.

The controlling unit may include a color determining unit to compare relative remaining amounts of the different color toners to determine which of the different color toners is relatively depleted, and a light source controlling unit to control at least half of the normal number of the plurality of light sources to scan a corresponding color image on the photosensitive medium.

Alternatively, the controlling unit may include a color determining unit to compare relative remaining amounts of the different color toners to determine which of the different color toners is relatively depleted and to determine the reduced number of the plurality of light sources according to relative depletedness of a color toner that is determined to be relatively depleted by the comparison, and a light source controlling unit to operate the reduced number of the plurality of light sources to scan a corresponding color image on the photosensitive medium.

The color determining unit determines one or more color toners that are depleted by multiplying a maximum remaining amount of toner from among the plurality of different color toners and a predetermined value that is less than 1 to obtain a product value, comparing the product value with each remaining amount of toner of the different color toners, and determining that the remaining amount of toner is the depleted remaining amount of toner when the remaining amount of toner is less than the product value. The controlling unit may include a color determining unit to determine a degree of depletedness of the depleted remaining amount of toner from among a plurality of degrees of depletedness associated with a plurality of reduced numbers of light sources, and a light source controlling unit to control the reduced number of light sources associated with the determined degree of depletedness to emit light to the photosensitive medium.

In another embodiment of the present general inventive concept an electrophotographic image forming apparatus, includes a photosensitive medium on which an electrostatic latent image that corresponds to a plurality of color toner images is formed, a multi-beam light source unit having a plurality of light sources, and a controlling unit to control the plurality of light sources to emit light to the photosensitive medium to form a first color toner image thereon and to control less than all of the plurality of light sources to emit light to the photosensitive medium to form a second color toner image thereon. The apparatus may further include a developing unit to apply a plurality of different color toners to the plurality of color toner images on the photosensitive medium such that more toner of a first color is applied to the photosensitive medium than toner of a second color when the first and second color toner images are the same.

Accordingly, in a method of controlling a plurality of light sources included in a multi-beam laser scanning unit in an electro-photographic image forming apparatus according to the various embodiments of the present general inventive concept, an image forming method, and an apparatus thereof, remaining amounts toner of printable colors are detected so that only some of the plurality of light sources are used for colors having remaining amounts of toner that are depleted when radiating light onto a photosensitive medium. Accordingly, without an additional image data conversion, the remaining amounts of toner can be evenly maintained to uniformly preserve the quality of printed images.

The various embodiments of the present general inventive concept can be written as computer readable code on a computer readable medium. The computer readable medium can be any data storage device that can store data which can be thereafter read by a computer system. Examples of the computer readable recording medium include read-only memory (ROM), random-access memory (RAM), CD-ROMS, magnetic tapes, floppy disks, optical data storage devices, and storage media such as carrier waves (i.e. transmission through the internet).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling a plurality of light sources in an electro-photographic image forming apparatus, the method comprising:
detecting remaining amounts of toner that correspond to printable colors;
detecting whether any color has a remaining amount of toner that is depleted based on the detected remaining amounts of toner; and
radiating light onto a photosensitive medium by using selected ones of the plurality of light sources with respect to the color having the detected remaining amount of toner that is depleted.

2. The method according to claim 1, wherein the plurality of light sources radiate light onto the photosensitive medium to form an electrostatic latent image.

3. The method according to claim 1, wherein the detecting of the remaining amounts of toners that correspond to the printable colors comprises detecting a color having a remaining amount of toner that is less than a product value of multiplying a maximum of the detected remaining amounts of toner by a predetermined value “x” (0<x<1).

4. The method according to claim 3, wherein the predetermined value “x” is set by one of a manufacturer and a user.

5. The method according to claim 1, wherein the radiating of the light comprises radiating light onto the photosensitive medium using one of the plurality of light sources for the color having the remaining amount of toner that is depleted and radiating light onto the photosensitive medium using two or more of the plurality of light sources for other colors that do not have remaining amounts of toner that are depleted.

6. An electro-photographic image forming method, the method comprising:
detecting remaining amounts of toner that correspond to printable colors;
detecting whether any color has a remaining amount of toner that is depleted based on the detected remaining amounts of toner;
radiating light onto a photosensitive medium by using selected ones of a plurality of light sources with respect to the color having the detected remaining amount of toner that is depleted; and
forming an image on a recording medium using the photosensitive medium onto which the light is radiated.

7. The method according to claim 6, wherein the printable colors include yellow, magenta, cyan, and black.

8. The method according to claim 6, wherein the detecting of the remaining amounts of toner that correspond to the printable colors comprises detecting a color having a remaining amount of toner that is less than a product value of multiplying a maximum of the detected remaining amounts of toner by a predetermined value “x” (0<x<1).

9. The method according to claim 6, wherein the radiating of the light comprises radiating the light onto the photosensitive medium using one of the plurality of light sources for the color having the remaining amount of toner that is depleted, and radiating light onto the photosensitive medium using two or more of the plurality of light sources for other colors that do not have remaining amounts of toner that are depleted.

10. The method according to claim 6, wherein the radiating of the light comprises:
determining a number of radiating light sources among the plurality of light sources to be in proportion to the detected remaining amounts of toner of a color having toner that is depleted; and
radiating the light onto the photosensitive medium using the determined number of light sources for the determined color having the remaining amount of toner that is depleted.

11. An electrophotographic image forming method of maintaining approximately uniform amounts of different color toners, the method comprising:
controlling a plurality of light sources in a multi-beam light scanning unit such that a normal number of the plurality of light sources emit light to a photosensitive medium for a color having a corresponding normal remaining amount of toner and a reduced number of the plurality of light sources emit light to the photosensitive medium for a color having a corresponding depleted remaining amount of toner.

12. The method according to claim 11, wherein the controlling of the plurality of light sources comprises:
comparing relative remaining amounts of the different color toners to determine which of the different color toners is relatively depleted; and
controlling at least half of the normal number of the plurality of light sources to scan a corresponding color image on the photosensitive medium.

13. The method according to claim 11, wherein the controlling of the plurality of light sources comprises:
comparing relative remaining amounts of the different color toners to determine which of the different color toners is relatively depleted;
determining the reduced number of the plurality of light sources according to the relative depletedness of a color toner that is determined to be relatively depleted by the comparison; and
operating the reduced number of the plurality of light sources to scan a corresponding color image on the photosensitive medium.

14. The method according to claim 11, wherein the controlling of the plurality of light sources comprises determining one or more color toners that are depleted by:
multiplying a maximum remaining amount of toner from among the plurality of different color toners and a predetermined value that is less than 1 to obtain a product value;
comparing the product value with each remaining amount of toner of the different color toners; and
determining that the remaining amount of toner is the depleted remaining amount of toner when the remaining amount of toner is less than the product value.

15. The method according to claim 11, wherein the controlling of the plurality of light sources comprises:
determining a degree of depletedness of the depleted remaining amount of toner from among a plurality of degrees of depletedness associated with a plurality of reduced numbers of light sources; and
controlling the reduced number of light sources associated with the determined degree of depletedness.

16. An electrophotographic image forming method, the method comprising:
comparing relative remaining amounts of a plurality of different color toners in a plurality of corresponding developing units; and
regulating a light scanning operation of a multi-beam laser scanning unit according to the comparison of the relative remaining amounts of the different color toners to operate different numbers of light sources for the different color toners such that the relative remaining amounts of the different color toners are maintained approximately uniform.

17. A computer-readable medium containing executable code to control a plurality of light sources in an electro-photographic image forming apparatus, the medium comprising:
executable code to control a sensor to detect remaining amounts of toner that correspond to printable colors and to detect whether any color has a remaining amount of toner that is depleted based on the detected remaining amounts of toner; and
executable code to control selected ones of the plurality of light sources to radiate light onto a photosensitive medium with respect to the color having the detected remaining amounts of toner that is depleted.

18. A computer-readable medium containing executable code to control an electro-photographic image forming method, the medium comprising:
executable code to control a sensor to detect remaining amounts of toner that correspond to printable colors and to detect whether any color has a remaining amount of toner that is depleted based on the detected remaining amounts of toner;
executable code to control selected ones of the plurality of light sources to radiate light onto a photosensitive medium with respect to the color having the detected remaining amount of toner that is depleted; and
executable code to control formation of an image on a recording medium using the photosensitive medium onto which the light is radiated.

19. An electro-photographic image forming apparatus comprising:
a photosensitive medium on which an electrostatic image is formed;
a plurality of light sources to radiate light onto a photosensitive medium;
a plurality of developing units charged with toner of printable colors;
a remaining toner detecting unit to detect remaining amounts of toner that correspond to the printable colors;
a color determining unit to determine a color having a remaining amount of toner that is depleted according to the detected remaining amounts of toner; and
a light source controlling unit to control the plurality of light sources so that selected ones of the plurality of light sources radiate light onto the photosensitive medium for the detected color having the remaining amount of toner that is depleted.

20. The apparatus according to claim 19, wherein the printable colors include yellow, magenta, cyan, and black.

21. The apparatus according to claim 19, wherein the color determining unit determines the color having the remaining amount of toner that is depleted by determining a color having the remaining amount of toner that is less than the product value of multiplying a maximum of the detected remaining amounts of toner by a predetermined value “x” (0<x<1) to be the color toner is depleted.

22. The apparatus according to claim 21, wherein the predetermined value “x” is set by one of a manufacturer and a user.

23. The apparatus according to claim 19, wherein the light source controlling unit controls the plurality of light sources so that one light source radiates light onto the photosensitive medium for the color having the remaining amount of toner that is depleted, and controls two or more of the plurality of light sources to radiate light onto the photosensitive medium for other colors that do not have remaining amounts of toner that are depleted.

24. The apparatus according to claim 19, wherein the light source controlling unit determines a number of radiating light sources among the plurality of light sources to be in proportion to the detected remaining amounts of toner with respect to the determined color having the remaining amount of toner that is depleted so that the determined number of light sources are radiated onto the photosensitive medium.

25. An electrophotographic image forming apparatus that maintains approximately uniform amounts of different color toners, the apparatus comprising:
a multi-beam light scanning unit including a plurality of light sources; and
a controlling unit to control the plurality of light sources such that a normal number of the plurality of light sources emit light to a photosensitive medium for a color having a corresponding normal remaining amount of toner and a reduced number of the plurality of light sources emit light to the photosensitive medium for a color having a corresponding depleted remaining amount of toner.

26. An electrophotographic image forming apparatus, comprising:
a photosensitive medium on which an electrostatic latent image that corresponds to a plurality of color toner images is formed;
a multi-beam light source unit having a plurality of light sources; and
a controlling unit to control the plurality of light sources to emit light to the photosensitive medium to form a first color toner image thereon and to control less than all of the plurality of light sources to emit light to the photosensitive medium to form a second color toner image thereon.

27. A controller to control a multi-beam laser scanning unit, the controller comprising:
a color determining unit to compare relative remaining amounts of a plurality of different color toners in a plurality of corresponding developing units; and
a light source controlling unit to regulate a light scanning operation of a multi-beam laser scanning unit according to the comparison of the relative remaining amounts of the different color toners to operate different numbers of light sources for the different color toners such that the relative remaining amounts of the different color toners are maintained approximately uniform.
